(19) United States
(12) Patent Application Publication
(10) Pub. No.: US 2002/0112137 A1
(43) Pub. Date: Aug. 15, 2002

(54) Partial trench body ties in sram cell

(75) Inventor: Theodore W. Houston, Richardson, TX (US)

Correspondence Address: TEXAS INSTRUMENTS INCORPORATED, P O BOX 655474, M/S 3999, DALLAS, TX, 75265

(73) Assignee: Texas Instruments Incorporated

(21) Appl. No.: 10/036,095

(22) Filed: Dec. 31, 2001

Related U.S. Application Data
(60) Provisional application No. 60/259,300, filed on Dec. 31, 2000.

(51) Int. Cl. G06F 12/04

(52) U.S. Cl. 711/200

(57) ABSTRACT

A silicon-on-insulator (SOI) SRAM memory cell having a plurality of MOS transistors wherein one or more of the conductive bodies of the transistors are connected by semiconductor material which extends beneath a partial (shallow) trench.

### CROSS-REFERENCE TO RELATED APPLICATION

This application claims priority from U.S. Provisional Application Serial No. 60/259,300 filed Dec. 31, 2000, which is hereby incorporated by reference.

### BACKGROUND AND SUMMARY OF THE INVENTION

The present invention generally relates to semiconductors and integrated circuits. More particularly, the present invention relates to the use of a partial trench in the substrate of an SRAM cell to connect related bodies to minimize floating body effects.

Modern silicon-on-insulator (SOI) technology for integrated circuit (IC) fabrication involves the formation of transistors, either bipolar or MOS, in certain regions or “mesas” within a layer of semiconductor material. The silicon mesas overlie a layer of an insulating material which overlies a silicon semiconductor substrate. In SOI technology, the silicon transistor mesas are isolated from the silicon substrate by an oxide insulating layer.

In an SOI MOS transistor, the body node or well underlying the transistor gate terminal is isolated from the bulk silicon substrate by the insulating layer. Thus, the body node is electrically floating unless a connection is made to the body node. In a partially-depleted MOS transistor with floating body, the transistor characteristics vary with variation of the voltage of the floating body. The general effect is to increase leakage currents and to cause imbalance between otherwise balanced transistors. This effect can be particularly sever for a pass transistor in an SRAM cell. When both source/drain nodes are high, the body node approaches the high voltage. Then if the bitline node is pulled low, there will be significant leakage even though the WL is held low. The effect is not as sever for the drive transistor of an SRAM cell where the source is held at Vss and the body node voltage excursion is limited by the diode from source to body.

To counter the inherent problems associated with the floating body node of an SOI transistor, it is known to connect the body node to the source terminal or to a fixed voltage. Conventional means for body contacts, either to the source or to a fixed voltage, take area that is not acceptable for an SRAM cell.

One form of an SOI IC is an SRAM. SRAMs include a “latch” (a cross-coupled pair of driver transistors) whose state corresponds to the stored data. The best combination of performance and standby leakage is obtained with CMOS latches comprising both n-MOS and p-MOS transistors. Thus a single well structure as can be used in DRAM is not applicable to CMOS SRAM.

Accordingly, it would be advantageous to provide an SRAM cell that can minimize floating body effects in the transistor's partially depleted state, without using buried contacts or ties that effect a significant area penalty. It is thus to the provision of such an improved SRAM cell that the present invention is primarily directed.

### SUMMARY OF THE INVENTION

The present invention is a silicon-on-insulator (SOI) SRAM memory cell which has a plurality of MOS transistors wherein buried semiconductor material extends beneath a partial trench to conductively connect bodies of separate transistors. The SRAM cell includes a substrate made of a semiconductor, with an insulating layer formed upon the substrate, such as an oxide layer. A semiconductor layer is formed on the insulating layer. At least a first portion of the semiconductor layer is doped a first conductivity type, and a plurality of isolating trenches are etched in region of first conductivity type to form a plurality of isolated conductive bodies. Transistors are formed in the region of first conductivity type with source and drains of second conductivity type.

At least one of the plurality of trenches is a partial trench which does not fully extend through the semiconductor layer to the insulating layer, and thus, does not fully electrically isolate the conductive body. Consequently, the conductive material of one body is in conductive contact with the conductive material of at least one adjacent body.

The present invention can be used with 4, 6, and 8 transistor SRAM memory cells, and the individual transistor can be n-channel or p-channel. For n-channel transistors, the first conductive type is a p-type material, and the second conductive type is an n-type material. Conversely, for n-channel transistors, the first conductive type is an n-type material, and the second conductive type is a p-type material.

The use of one or more partial trenches to conductively connect related bodies minimizes floating body effects in the partially depleted state of the transistors of the SRAM memory cell without the use of buried contacts or ties. The present invention therefore reduces the noise margin in the SRAM cell without a significant area penalty.

### BRIEF DESCRIPTION OF THE DRAWINGS

FIG. 1 is a schematic of a 6 transistor SRAM memory cell embodied with partial trench body ties.

FIG. 2A is a plan view, and FIG. 2B a section, of two SOI NMOS transistors having respective P-type conductive bodies connected with a partial trench.

FIGS. 3A-3D are a sequential set of drawings which illustrate a process sequence for fabrication of the described structures.

### DETAILED DESCRIPTION OF THE INVENTION

With reference to the figures in which like numerals represent like elements throughout, FIG. 1 is a schematic of a 6 transistor SRAM memory cell 10 embodied with partial trench body ties 12 and 14. NMOS transistors T1 and T2 comprise a latch, i.e. a cross-coupled pair of driver transistors whose state corresponds to the stored data. PMOS transistors T3 and T4 provide a load to the latch to maintain the logical state, and NMOS pass transistors T5 and T6 allow the access to the cell upon the activation of the word line.

In fabrication of the silicon-on-insulator (SOI) SRAM memory cell 10, the partial trench body ties 12 and 14 conductively connect the bodies of matched transistor pairs. Thus, partial trench body tie 12 conductively couples the bodies of PMOS loads T3 and T4, and partial trench body tie 14 conductively couples the bodies of NMOS drivers T1 and T2.

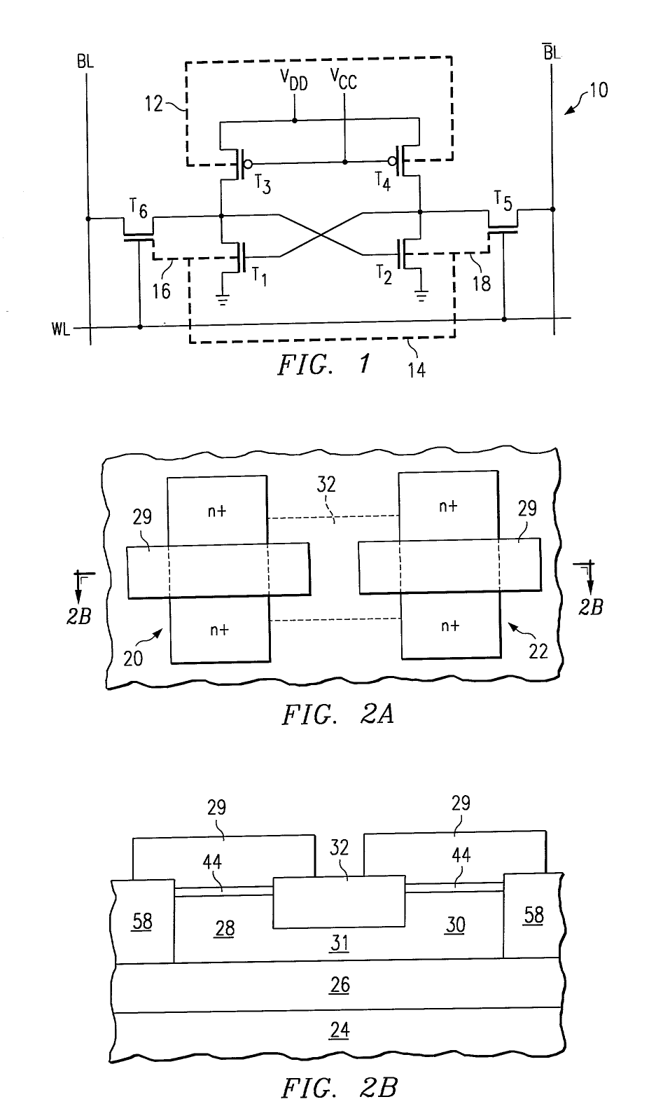

FIG. 2A illustrates two SOI NMOS field effect transistors (FETs) 20, 22 having respective P-type conductive bodies 28, 30 connected with a body tie 31 under partial trench 32, and FIG. 2B is a section view of the same structure, taken along the line shown in FIG. 2A..

The SOI SRAM memory cell is comprised of a substrate 24, which is typically silicon, and an insulating layer 26 is formed upon the substrate 24. The insulating layer 26 is a buried oxide layer or other non-conductive material as is known in the art of fabricating SOI transistors. Upon the insulating layer 26 is placed a first conductive layer, which will be either N or P type material depending upon whether one is fabricating a PMOS or NMOS transistor. If the transistors are NMOS, such as transistors 20 and 22, then the first conductive layer is a P type material, such as Boron. If the transistor is PMOS, then the first conductive type is an N-type material, such as Arsenic, Phosphorus, and Antimony.

To electrically isolate a plurality of conductive bodies, a plurality of dielectric-filled trenches 58 are made in the first conductive layer. These full trenches 58 separate P-type conductive bodies from each other, to fully isolate the corresponding NMOS transistors.

The preferred structure and process also provide partial dielectric-filled trenches, which interrupt the surface of the semiconductor layer but do not extend fully down to the buried insulator layer. Thus trench 32 is a partial trench, which leaves a portion 31 of the body material in place. This remaining portion 31 is referred to herein as a partial trench body tie, and ohmically connects body 28 of transistor 20 to body 30 of transistor 22.

Thus, the conductive bodies of adjacent transistors can be electrically linked with the selective use of partial trenches in the first conductive layer. Full trenches, such as trench 58, which extend completely to the insulating layer 26, can be used in conjunction with partial trenches, such as partial trench 32, within the same SRAM memory cell, or series of SRAM cells. Alternately, the partial trench 32 can be ohmically connected to a source voltage, and thereby provide a source voltage to all other bodies in conductive contact therewith.

Conductive gates 29, insulated from bodies 28/30 by a very thin gate oxide 44, laterally separate source and drain regions 38 from each other, to define operative transistors.

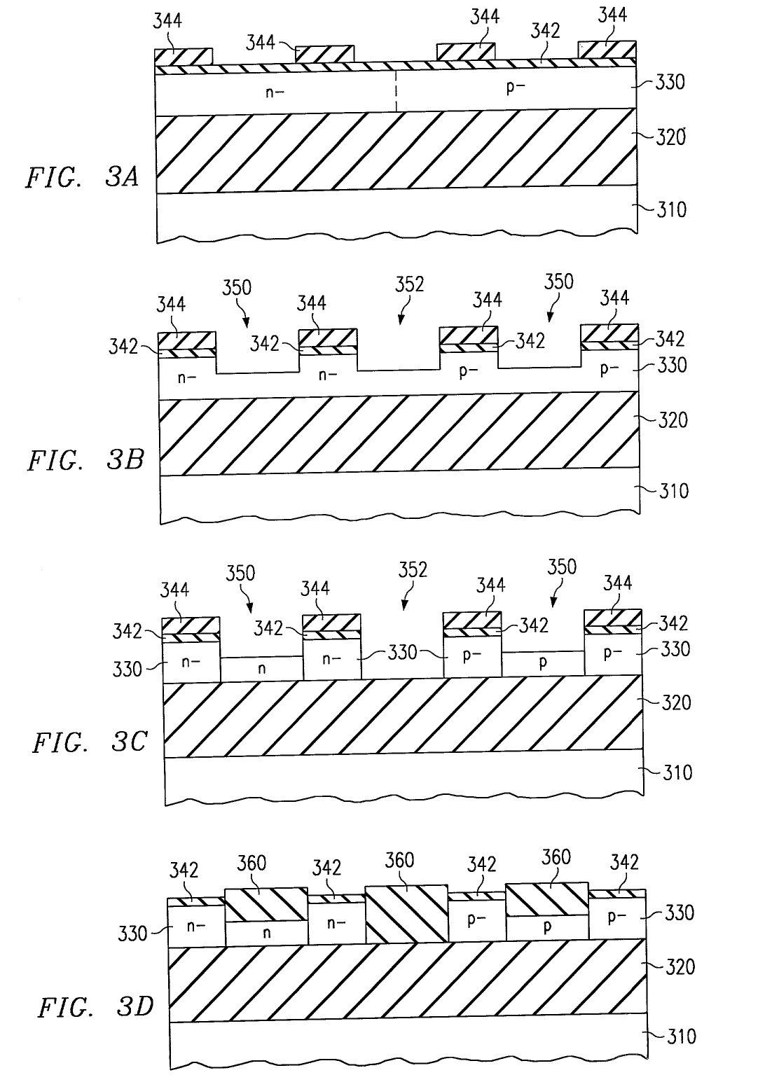

FIGS. 3A-3D are a sequential set of drawings which illustrate a process sequence for fabrication of the described structures. In a sample embodiment, the process sequence can include the steps of:

start with silicon layer 330 on insulator 320 (on substrate 310)

form pad oxide 342

do channel implants

deposit, pattern and etch the nitride 344 for active pattern

This produces the structure of FIG. 3A.

(Optional) implant into the isolation region. This is to increase the doping in what will be the partial trench. This requires a pattern step if both n and p are implanted, but not if the partial trench is used only for one type (n-channel or p-channel)

Partially etch the trench.

This produces the structure of FIG. 3B.

(Optional) implant into the isolation region..

Deposit resist and pattern to cover partial trench region.

Complete trench etch.

This produces the structure of FIG. 3C.

Fill trench with a dielectric 360, planarize, and remove nitride.

This produces the structure of FIG. 3D.

While there has been shown a preferred embodiment of the present invention, it is to be understood that certain changes may be made in the forms and arrangement of the elements and steps of the method without departing from the underlying spirit and scope of the invention as is set forth in the claims.

For example, while the partial trenches are shown in FIG. 1 to connect the bodies of only pairs of transistors, the bodies of any number of transistors can be interconnected if desired, using the buried interconnection beneath the partial trench isolation.

For another example, there can also be advantages of process simplification in the doping of the partial trench if partial trench is used only for p-channel or only for n-channel.

Furthermore, the partial trench can be used in any SOI SRAM memory cell, such as a 4, 6, or 8 transistor (two-port) SRAM cell.

The partial trenches and/or full trenches 58 can simply be filled with oxide, or the trenches can be lined with other nonconductive material instead of or in addition to the oxide.

For another example, the partial trenches can also be used between like conductive bodies of NMOS and like conductive bodies of PMOS transistors, even though the transistors may be in the same or different SRAM cell.

For another example, the disclosed tie can be used to connect depletion-mode devices as well as to connect enhancement-mode devices.

What is claimed is:

1. An SRAM cell, comprising:
an insulating layer;
a plurality of conductive bodies formed upon the insulating layer, each body being a first conductive type, and each body having a transistor formed thereupon comprised of a source region, a gate, and a drain region, the source region and drain region comprised of a second conductive type, and the transistor selectively allowing a channel to form between the source region and drain region; and
a plurality of trenches electrically isolating each of the plurality of bodies, wherein at least one of the trenches is a partial trench such that the conductive material of one body is in conductive contact with the conductive material of an adjacent body.

2. The SRAM cell of claim 1, wherein the plurality of trenches are each partial trenches.

3. The SRAM cell of claim 1, wherein the SRAM cell is comprised of 6 transistors.

4. The SRAM cell of claim 1, wherein the transistors of the SRAM cell are n-channel transistors, and the plurality of bodies are comprised of a p-type conductive material.

5. The SRAM cell of claim 1, wherein the transistors of the SRAM cell are p-channel transistors, and the plurality of bodies are comprised of an n-type conductive material.

6. The SRAM cell of claim 1, wherein the partial trench places the conductive material of at least one body in conductive contact with a supply voltage.

7. In an SRAM cell, a pair of transistors comprising:
a first transistor formed on a first conductive body of a first conductive type material overlying an insulating layer; and
a second transistor formed on a second conductive body of the first conductive type material, the second body overlying the insulating layer,
wherein a partial trench partially isolates the first conductive body from the second conductive body such that the conductive material of the first body is in conductive contact with the conductive material of the second body.

8. The pair of transistors of claim 7, wherein the first transistor and second transistor are n-channel transistors, and the first conductive type material is P-type material.

9. The pair of transistors of claim 7, wherein the first transistor and second transistor are p-channel transistors, and the first conductive type material is N-type material.

10. A method of fabricating an SRAM cell, comprising the steps of:
forming a semiconductor layer on an insulating layer;
forming a plurality of trenches in the semiconductor layer such that a plurality of electrically isolated bodies are formed upon the insulating layer, and wherein at least one trench is a partial trench such that at least two bodies are in partial conductive contact;
forming transistors in the isolated bodies such that the body regions of at least two of the transistors are electrically connected; where the at least two said transistors are of the same conductivity type.

11. The method of claim 10, wherein the step of forming trenches is forming a plurality of partial trenches such that each body is partial conductive contact with at least one other body.

12. The method of claim 10, wherein the steps of the method form an SRAM memory cell comprised of 6 transistors.

13. A memory array comprised of stripes of n-channel transistors and stripes of p-channel transistors formed on an insulator wherein partial trench isolation is used to connect to the body of at least one transistor within a stripe.

14. The memory array of claim 13 in which the at least one transistor is n-channel.

15. The memory array of claim 13 in which the at least one transistor is p-channel.

16. The memory array of claim 13 in which the n-channel and p-channel transistors are isolated by full trench isolation.

17. The memory array of claim 13 in which the bodies of a plurality of transistors of the same type are interconnected by partial trench.

18. The memory array of claim 17 in which the bodies of transistors of the other type are fully isolated by full trench isolation.

19. The memory array of claim 13 wherein the body of the at least on transistor is connected to a supply voltage.

20. The memory array of claim 13 wherein the body of the at least on transistor is connected to the body of a second transistor of the same type.

21. The memory array of claim 20 wherein the two transistors are within the same memory cell.

22. The memory array of claim 20 wherein the two transistors are in different memory cells.

23. The memory array of claim 20 wherein the at least one transistor is a drive transistor and the second transistor is a pass gate transistor.

24. The memory array of claim 13 wherein within at least one stripe, a partial trench extends essentially the full length of the stripe.

25. The memory array of claim 24 wherein a full trench extends essentially the full length between the at least on stripe and an adjacent stripe.

26. The memory array of claim 24 in which the partial trench is connected to a supply voltage.

27. The SRAM cell of claim 1 further comprising a plurality of conductive bodies of the second conductivity type, wherein the conductive bodies of the second conductivity type are electrically isolated from the conductive bodies of the first conductivity type by a full trench.

28. The SRAM cell of claim 2 in which the conductive bodies of the second conductivity type are isolated by full trench isolation.

29. The SRAM cell of claim 2 in which at least two of the conductive bodies of the second conductivity type are conductively connected by partial trench.

30. The SRAM cell of claim 7 wherein the first transistor is a driver transistor and the second transistor is a pass gate transistor.

31. The method of claim 10 wherein the step of forming transistors comprises forming transistors of two conductivity types where the transistors of one conductivity type are electrically isolated from the transistors of the other conductivity type by full trench isolation.

32. The SRAM cell of claim 1, wherein the connection to a supply voltage is made by connection to the source region of a transistor.

33. A. A semiconductor-on-insulator integrated circuit structure, comprising:
at least two transistors, each comprising first and second source/drain regions of a first conductivity type, separated by a conductivity-modulated body region of a second conductivity type; and
a body extension volume, comprising material of said second conductivity type beneath an insulating partial trench, and extending between said respective body regions of said transistors to provide ohmic connection therebetween;
whereby said body regions are maintained at substantially equal voltages without requiring any additional contact structure.
